(19) United States
(12) Patent Application Publication
(10) Pub. No.: US 2024/0239422 A1
(43) Pub. Date: Jul. 18, 2024

(54) Flexible Truck Tail

(71) Applicant: Laszlo Molnar, Mukilteo, WA (US)

(72) Inventor: Laszlo Molnar, Mukilteo, WA (US)

(21) Appl. No.: 18/098,641

(22) Filed: Jan. 18, 2023

(51) Int. Cl. B62D 35/00

(52) U.S. Cl. CPC B62D 35/004

(57) ABSTRACT

A flexible tail may maximize an aerodynamic profile of a vehicle. The flexible tail may include a pyramidal structure formed by inflatable tubes disposed within a casing of flexible, tear-resistant material. The flexible tail may have integrated bungee ropes operable to adjust, fold, or retract the flexible tail for storage. Geometry and flexibility of the tail may reduce wake at the rear of the vehicle, reducing drag and improving fuel efficiency.

### BACKGROUND

Every day, trucks move more than half of the freight in the United States. Large trucks that are used for moving freight are heavy. The immense weight of these trucks results in low fuel efficiencies and, therefore, high operation costs. Vehicles such as these are aerodynamically inefficient. Due to fiscal and environmental impacts of a large fleet of low fuel efficiency vehicles, industries are looking to embrace new technologies that improve fuel efficiencies.

### SUMMARY

The following presents a simplified summary of the disclosure to provide a brief overview to the reader in which to present key concepts. A more detailed description of the disclosure can be found in subsequent sections of this application.

The instant application discloses, among other things, a flexible tail designed to maximize an aerodynamic profile of a vehicle. The flexible tail may attach to a rear of a vehicle, for example, to a base of a tractor-trailer combination vehicle, such as a commercial semi-trailer truck. In one implementation, the flexible tail may comprise a pyramidal structure formed by a tubular framing disposed within a sheet of flexible, tear-resistant material. The tubular framing may provide a framework for lateral faces, an apex, and a polygonal base of the pyramidal structure. The tubular framing may include inflatable tubes which expand on pressure of compressed air derived from existing reservoirs in the vehicle's air brake system, for example. The flexible tail may be laterally disposed at the rear of the vehicle such that the apex points opposite from a direction in which the vehicle travels. Geometry and flexibility of the tail may reduce wake at the rear of the vehicle, reducing drag and improving fuel efficiency. In one implementation, it may improve fuel efficiency of a tractor-trailer combination vehicle by about 25%.

Flexibility of the tail may also ensure usability when attached to a vehicle on the road. In one implementation, it may include integrated bungee ropes operable to adjust, to fold, or to retract the tail for storage at a top of the vehicle, allowing a user full access to its freight. While increasing fuel efficiency through aerodynamics, the flexible tail may also act as an airbag to protect a driver or freight during a collision.

Further features of this disclosure are detailed in subsequent sections and the attached drawings of the instant application.

### BRIEF DESCRIPTION OF THE DRAWINGS

FIG. 1 illustrates a perspective interior view of a flexible tail, according to one implementation.

FIG. 2 illustrates a top perspective view of a vehicle with a flexible tail attached, according to one implementation.

FIG. 3 illustrates a top perspective view of a deflated and folded flexible tail stored at a top of a vehicle by integrated bungee ropes, according to one implementation.

FIG. 4 illustrates inflatable tubes that may create joints to support a flexible tail, according to one implementation.

FIG. 5 illustrates a computational fluid dynamics (CFD) flow pattern map showing aerodynamics of a rear of a trailer of a moving tractor-trailer combination vehicle without a flexible tail attached.

FIG. 6 illustrates a computational fluid dynamics (CFD) flow pattern map showing aerodynamics of a rear of a trailer fitted with a flexible tail.

### DETAILED DESCRIPTION

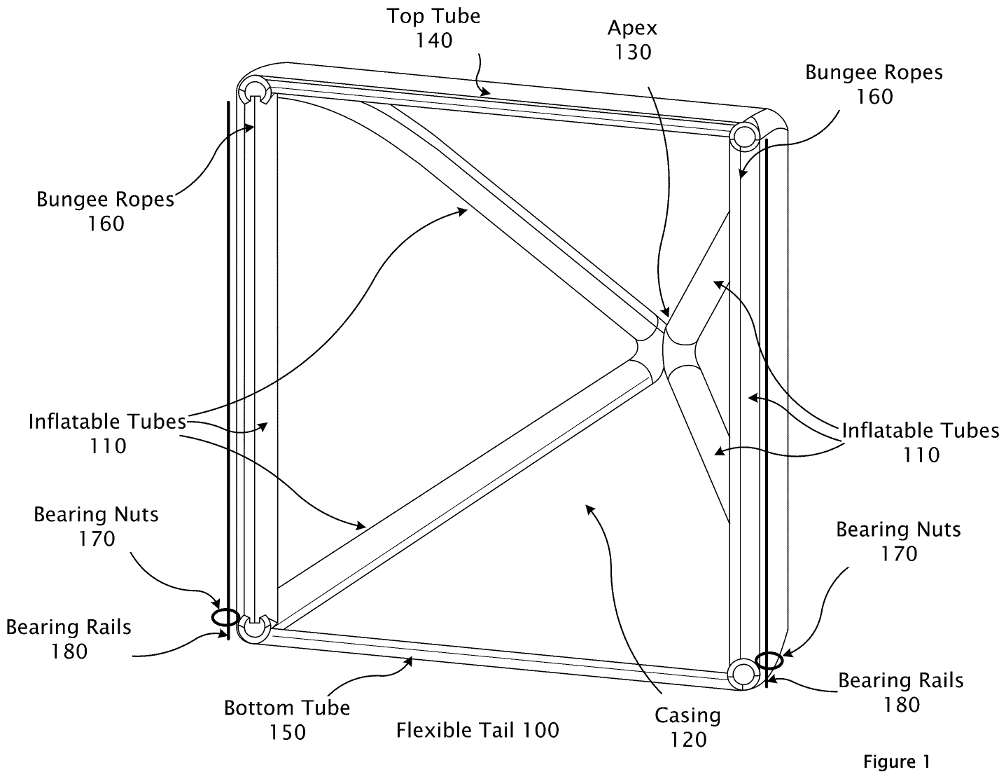

FIG. 1 illustrates a perspective interior view of Flexible Tail 100, according to one implementation. Flexible Tail 100 may comprise a pyramidal structure formed by a tubular framing disposed within Casing 120. The tubular framing may include Inflatable Tubes 110, Top Tube 140, and Bottom Tube 150. Inflatable Tubes 110 may provide a framework for lateral faces of the pyramidal structure, which may meet to form Apex 130. Inflatable Tubes 110 may expand on pressure of compressed air derived from existing reservoirs in the vehicle's air brake system, for example. Two vertically-disposed Inflatable Tubes 110 may couple to Top Tube 140 and Bottom Tube 150 to define a polygonal base, for example, a rectangular or square base, of the pyramidal structure. Top Tube 140 and Bottom Tube 150 may be more rigid than Inflatable Tubes 110. For example, they may be made of plastic, composite, metal or another material, and may be non-inflatable. Top Tube 140 may be fixed to a top edge of a rear of a vehicle or trailer.

Casing 120 may fittingly cover or enclose the tubular framing while leaving an opening for the polygonal base. In another implementation, Casing 120 may cover or enclose the polygonal base. Casing 120 may comprise a sheet of flexible non-porous, tear-resistant material, for example, ripstop nylon, polyethylene terephthalate, carbon fiber reinforced polymer, or parafoil material. Inflatable Tubes 110 may be made of a same or different material as Casing 120, or may be integral to Casing 120. Inflatable Tubes 110 may include removable bladders which may facilitate repair in an event of damage or leakage.

Flexible Tail 100 may attach to a rear of a vehicle, for example, to a base of tractor-trailer combination vehicle such as a semi-trailer truck, or to another vehicle such as a box truck or bus. Flexible Tail 100 may maximize an aerodynamic profile of the vehicle. The flexible tail may be laterally disposed at the rear of the vehicle such that Apex 130 points opposite from a direction in which the vehicle travels. Geometry and flexibility of Flexible Tail 100 may reduce wake at the rear of the vehicle, reducing drag and improving fuel efficiency.

Air in Inflatable Tubes 110 may hold a solid shape for a desired duration. A user may inflate or deflate manually, or it may be done automatically, for example, upon the vehicle reaching a speed, a freight reaching a weight, an occurrence of high winds or environmental conditions, or a combination of these or other factors that may affect fuel efficiency of the vehicle.

Flexible Tail 100 may include integrated Bungee Ropes 160 operable to adjust, to fold, or to retract the tail for storage on top of the vehicle or another location. In one implementation, Bungee Ropes 160 may be integrated within Inflatable Tubes 110 or Casing 120. In this example, Bearing Nuts 170 may attach to the two moveable lower corners to guide the moveable lower corners up or down Bearing Rails 180. Bearing Rails 180 may comprise two cables or rails secured by rivets, for example, to each lateral side of a rear door of the vehicle. Bearing Nuts 170 may guide the moveable lower corners up as Bungee Ropes 160 corrugate the Flexible Tail 100 to the roof for storage, or guide them down Bearing Rails 180 as the Flexible Tail 100 inflates and moves down into position at a rear of the vehicle. Flexible Tail 100 may retract automatically upon opening of a rear door or at a push of a button, for example. In another implementation, Bungee Ropes 160 may attach to a lower corner of Flexible Tail 100 and to an upper tube on an opposite end to fold or retract Flexible Tail 100.

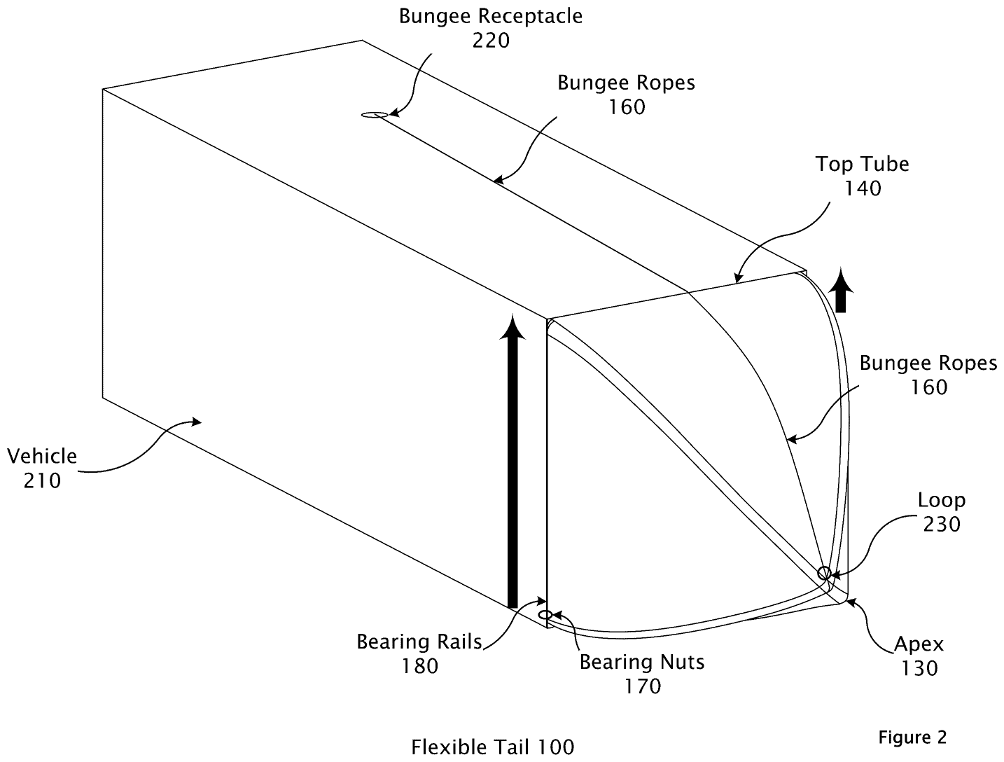

FIG. 2 illustrates a top perspective view of a Vehicle 210 with a Flexible Tail 100 attached, according to one implementation. Vehicle 210 may comprise a tractor-trailer combination vehicle, a box truck, a bus, or another vehicle. Geometry and flexibility of Flexible Tail 100 may reduce wake at the rear of Vehicle 210 in motion, reducing drag and improving fuel efficiency. Flexible Tail 100 may be sized to affix to and optimize aerodynamics on various types of vehicles.

Bungee Ropes 160 may be integrated into Flexible Tail 100 to adjust, to fold, or to retract the tail for storage on top of the vehicle or another location. Bungee Ropes 160 may comprise an elastic material that absorbs shock. Retraction of Flexible Tail 100 by Bungee Ropes 160 may provide easy access to freight on Vehicle 210, or it may allow visibility of a company logo, an advertisement, or safety information on a rear door, for example.

In one implementation, Bungee Receptacle 220 may secure to a top of Vehicle 210 and contain one or more coils of Bungee Ropes 160. Bungee Ropes 160 may extend from Bungee Receptacle 220 when Flexible Tail 100 inflates and becomes positioned at a rear of Vehicle 210. Flexible Tail 100 may be laterally disposed at the rear of Vehicle 210 such that Apex 130 points away from a direction in which Vehicle 210 travels. Top Tube 140 may be fixed to a top edge of a rear of Vehicle 210, for example, above a rear door of a trailer. Bungee Ropes 160 may pass through and be guided by Loop 230 located at Apex 130.

Bearing Nuts 170 may attach to the two moveable lower corners of Flexible Tail 100 to guide the moveable lower corners up or down Bearing Rails 180. Bearing Rails 180 may comprise two cables or rails secured by rivets, for example, to each lateral side of a rear door of Vehicle 210. Bearing Nuts 170 may guide the moveable lower corners down Bearing Rails 180 as the Flexible Tail 100 inflates and moves down into position at a rear of the vehicle. Bearing Nuts 170 may guide the moveable lower corners upward as Bungee Ropes 160 corrugate Flexible Tail 100 to the roof for storage. Flexible Tail 100 may retract automatically upon powering off of an engine, opening of a rear door, or pushing of a button, for example. Flexible Tail 100 may deflate before or during retraction. Upon retraction, Bungee Ropes 160 may return to Bungee Receptacle 220 for storage.

Flexible Tail 100 may be used with other aerodynamic devices or accessories, for example, side skirts. While increasing fuel efficiency through aerodynamics, Flexible Tail 100 may also act as an airbag to protect a driver or freight during a collision.

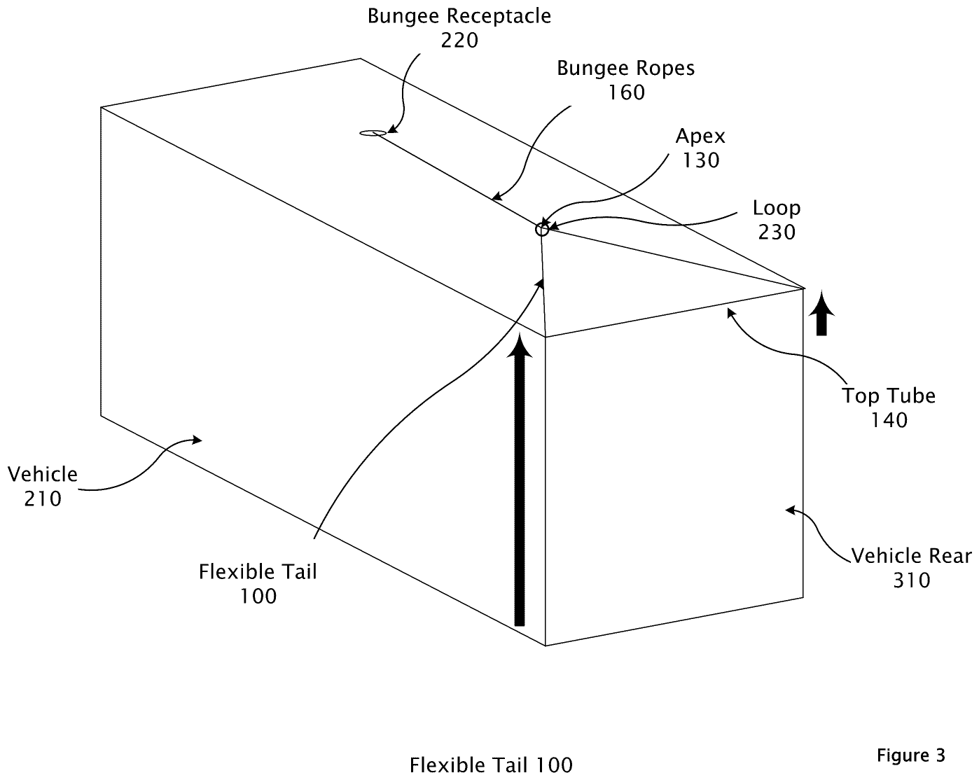

FIG. 3 illustrates a top perspective view of a deflated and folded flexible tail stored at a top of a vehicle by integrated bungee ropes, according to one implementation. Bungee Ropes 160 may be integrated into Flexible Tail 100 to adjust, to fold, or to retract the tail for storage on top of Vehicle 210 or another location. Retraction of Flexible Tail 100 by Bungee Ropes 160 may provide easy access to freight through Vehicle Rear 310, allow visibility of a company logo, an advertisement, or safety information on Vehicle Rear 310, for example, or protect Flexible Tail 100 when not in use.

Top Tube 140 may be fixed to a top edge of a rear of Vehicle 210 to secure Flexible Tail 100 to the vehicle. In one implementation, Bungee Receptacle 220 may secure to a top of Vehicle 210 and contain one or more coils of Bungee Ropes 160. Bungee Ropes 160 may extend from Bungee Receptacle 220 when Flexible Tail 100 inflates and becomes positioned at a rear of Vehicle 210. Flexible Tail 100 may be laterally disposed at the rear of Vehicle 210 such that Apex 130 points away from a direction in which Vehicle 210 travels. Bungee Ropes 160 may pass through Loop 230 located at Apex 130.

Flexible Tail 100 may retract automatically upon powering off of an engine, opening of a rear door, or pushing of a button by a Vehicle 210 operator, for example. Flexible Tail 100 may deflate before or during retraction. Upon retraction, Bungee Ropes 160 may return to Bungee Receptacle 220 for storage.

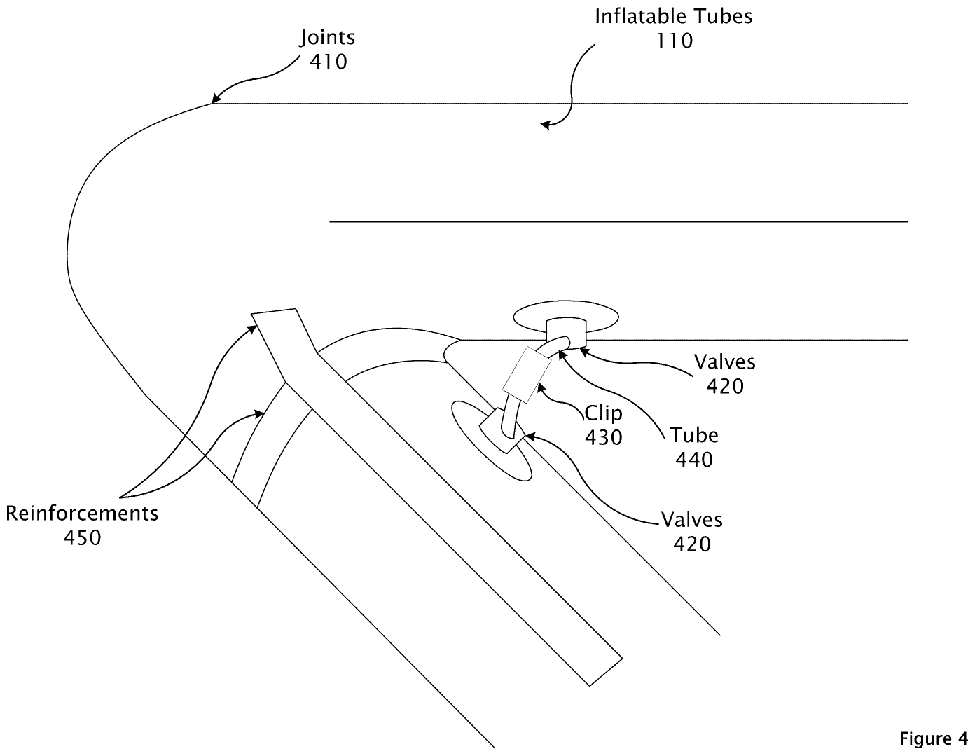

FIG. 4 illustrates Inflatable Tubes 110 that may couple to form Joints 410 to support a Flexible Tail 100, according to one implementation. Joints 410 may help form the framework for the pyramidal structure of Flexible Tail 100 and may allow air to flow freely through multiple Inflatable Tubes 110. Inflatable Tubes 110 may be made of a flexible non-porous, tear-resistant material, for example, ripstop nylon, polyethylene terephthalate, carbon fiber reinforced polymer, parafoil material, or any combination of these or other materials. Inflatable Tubes 110 may expand on pressure of compressed air derived from existing reservoirs in the vehicle's air brake system. The compressed air may be controlled by the vehicle operator, for example.

Inflatable Tubes 110 may be made of a same or different material as Casing 120, or may be integral to Casing 120. Inflatable Tubes 110 may include removable bladders which may facilitate repair in an event of damage or leakage. Inflatable Tubes 110 may include one or more inflation or deflation Valves 420. In one implementation, Inflatable Tubes 110 may include a single inflation and deflation point that fills or deflates all Inflatable Tubes 110 of Flexible Tail 100. In another implementation, Inflatable Tubes 110 may include a plurality of inflation or deflation Valves 420 for filling or releasing of air for independent bladders. Inflatable Tubes 110 may include various parts or accessories, including Clip 430 or Tube 440, which may help prevent leakage of air from or between Inflatable Tubes 110. Inflatable Tubes 110 may include Reinforcements 450, for example, stitched-in patches of polyethylene terephthalate, to enhance durability of Inflatable Tubes 110.

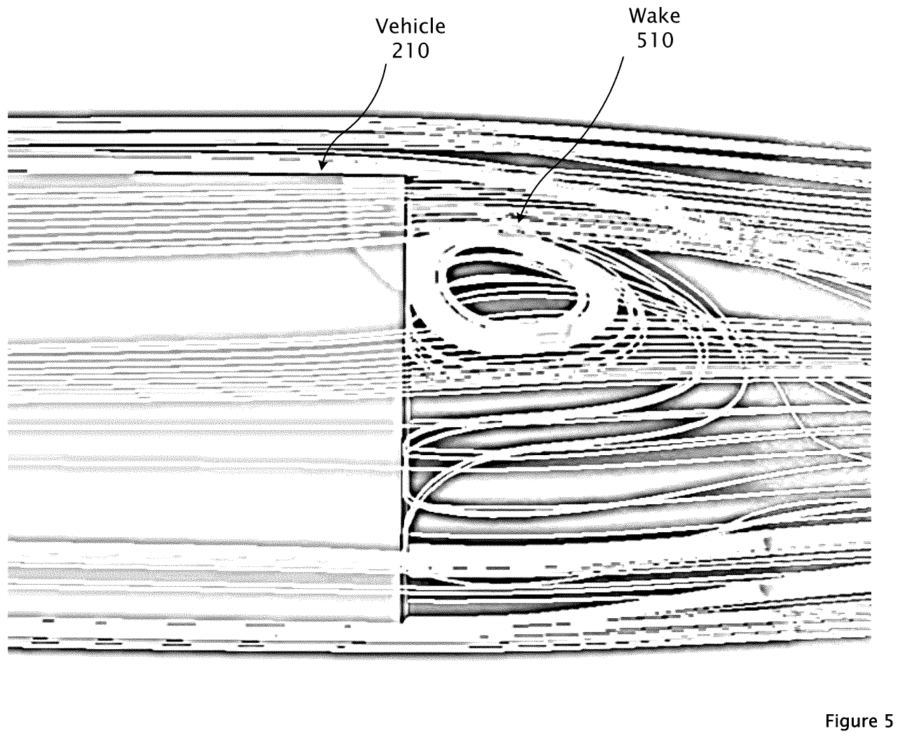

FIG. 5 illustrates a computational fluid dynamics (CFD) flow pattern map showing aerodynamics of a rear of a trailer of a moving Vehicle 210 without a flexible tail attached. In this example, Vehicle 210 may include a trailer attached behind a commercial semi-trailer truck. High pressure at a front of the truck as it travels, combined with low pressure at a front of the attached trailer may yield a high net pressure differential from the front of the truck to the rear of the trailer. The high net pressure differential may generate a downward force, resulting in a substantial amount of Wake 510 at the rear of the trailer and drag on the tractor-trailer combination vehicle.

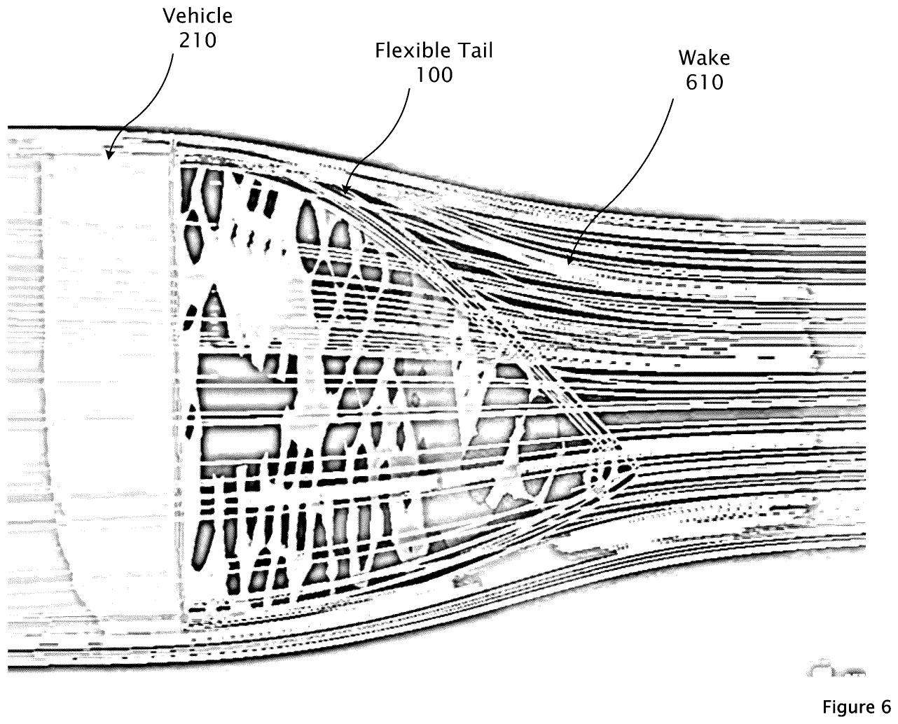

FIG. 6 illustrates a computational fluid dynamics (CFD) flow pattern map showing aerodynamics of a rear of a trailer fitted with Flexible Tail 100. Geometry and flexibility of Flexible Tail 100 may reduce Wake 610 at the rear of the vehicle by increasing pressure at the rear of the trailer. This may reduce the high net pressure differential, significantly reducing Wake 610 and net drag on Vehicle 210, and improving fuel efficiencies.

1. A flexible tail, comprising:
a frame, comprising:
a plurality of inflatable tubes, the inflatable tubes disposed to form lateral faces of a pyramidal structure, wherein the inflatable tubes form joints that meet to form an apex of the pyramidal structure;
a bottom tube;
a top tube, the top tube operable to attach to a top edge of a rear end of a vehicle, wherein the top tube and bottom tube are coupled to two vertical inflatable tubes to form a polygonal base of the pyramidal base;
a casing, the casing comprising main panels that hold structural elements of the frame; and
a retraction device, the retraction device secured to the flexible tail.

2. The flexible tail of claim 1, wherein the inflatable tubes include removable bladders.

3. The flexible tail of claim 1, wherein the inflatable tubes are made of materials from the list containing ripstop nylon, polyethylene terephthalate, carbon fiber reinforced polymer, and parafoil material.

4. The flexible tail of claim 1, wherein the casing comprises a flexible non-porous, tear-resistant material;

5. The flexible tail of claim 1, wherein the casing is made from the list containing ripstop nylon, polyethylene terephthalate, carbon fiber reinforced polymer, and parafoil material.

6. The flexible tail of claim 1, wherein the retraction device comprises a bungee rope.

7. The flexible tail of claim 1, wherein the inflatable tubes include an inflation valve and deflation valve.

8. The flexible tail of claim 6, wherein the inflation valve is operable to receive air from a compressed air reservoir of a vehicle air brake system.

9. The flexible tail of claim 1, wherein the inflatable tubes include a single inflation point that inflates a plurality of or all inflatable tubes of the flexible tail.

10. The flexible tail of claim 1, wherein the inflatable tubes include a single inflation point that inflates a plurality or all of the inflatable tubes of the flexible tail.

11. The flexible tail of claim 1, further operable to act as a rear airbag during a collision.

12. The flexible tail of claim 1, further comprising a bearing nut, the bearing nut comprising a ring secured to two lower corners of the pyramidal structure, wherein the bearing nut is coupled to a sliding rail, the sliding rail attached to two sides of a rear door of a vehicle or trailer, the bearing nut operable to slide up or down the sliding rail.
